(19) United States
(12) Patent Application Publication
(10) Pub. No.: US 2025/0245183 A1
(43) Pub. Date: Jul. 31, 2025

(54) ADVANCED HUMANOID ROBOTS WITH BUILT IN COMPUTER FOR REAL TIME APPLICATIONS

(71) Applicant: EMAGE VISION PTE. LTD., Singapore (SG)

(72) Inventors: Soon Wei WONG, Signapore (SG); Srinivas Kundapura PARAMESHWARA, Bengaluru (IN); Rajashankar MAYYA, Bangalore (MY); Pragnesh VIRANI, Singapore (SG)

(73) Assignee: EMAGE VISION PTE. LTD., Singapore (SG)

(21) Appl. No.: 19/040,586

(22) Filed: Jan. 29, 2025

(30) Foreign Application Priority Data
Jan. 30, 2024 (SG) SG 10202400267Q

(51) Int. Cl. G06F 13/40; G06F 9/4401; G06F 9/451; G06N 3/008

(52) U.S. Cl. CPC G06F 13/4068; G06F 9/4411; G06F 9/451; G06N 3/008

(57) ABSTRACT

A coordinated control system designed with a small form factor that can be located within a robot or an automated inline manufacturing system, comprising: an on board advanced distributed control hardware configured with artificial intelligence enabled processors incorporated within a System on Module (SOM) board, each SOM comprising four processors or nodes; interfaced with a cameras, motors, general purpose I/O through I2C expander, audio interface, Internet, wireless communication such as WiFi and Bluetooth to send and receive commands and any other data; electrically connected to a plurality of sensors for perceiving the environment and collecting data from infrared, tactile, proximity and other types of sensors; an external host flashing computer dedicated for uploading/downloading firmware, cloning and configuration setup; a non-volatile memory for storing control algorithms, configuration files and other essential data; a HDMI based user interface for robot operation, training and setup; USB C or Ethernet based internal star network for high-speed communication bypassing the standard PCI bus interface bus; an Ethernet switch board enabling multiple boards to access the Ethernet for both internal communication within the star network as well as external Internet access.

### CROSS-REFERENCE TO RELATED APPLICATIONS

This application claims the benefit of priority to Application No. SG 10202400267Q, filed Jan. 30, 2024 in Singapore, the entire disclosure of which is incorporated herein by reference.

### TECHNICAL FIELD

The present invention relates to a system and method to increase the operational speed of robots employed in real time applications by implementing an Advanced Distributed Computing Hardware (ADCH) system with a small form factor that is capable of performing parallel computing for multi-tasking processes. The present invention also provides for implementation of end-to-end autonomous standalone robots by incorporating the ADCH into the robot comprising Digital signal processor boards, capable of running multiple neural networks in parallel and processing extensive data from Vision systems, array of interface devices and sensors supported by Artificial intelligence inferencing, Deep learning and reinforced learning software algorithms resulting in a powerful and effective system.

### BACKGROUND

Robots are electro-mechanical assemblies that are controlled by one or more computer programs and/or electronic circuitry. Autonomous robots can perform desired tasks in unstructured environments without continuous human intervention. Semi-autonomous robots and non-autonomous robots, in contrast, often require human intervention in the form of training to load, unload a certain object or perform an activity on it such as sorting, machining, packing, etc. Robots are used in a variety of fields, including for example, manufacturing, space exploration, pharma, surgery, automotive, etc. Specialised robots are generally designed to perform a single task or a single set of tasks like moving from one point to another and perform multiple tasks along the way or at a given destination before being instructed to execute a new task. Humanoid robots are a category of robots that attempt to emulate certain human tasks including but not limited to messy and dangerous jobs amongst many other tasks. A humanoid robot is usually built to have anthropomorphic characteristics capable of understanding and interpreting human commands through motion. A humanoid might be designed for functional purposes, such as interacting with human tools and environments or more intelligent tasks by using artificial intelligence and continuous machine learning. In some cases, humanoid robots may also have heads designed to replicate human sensory features such as eyes or cars so they can be programmed to view, perceive, and understand the operating environment, hear instructions, and subsequently act on them based on what they are programmed to do.

Conventional humanoid robots do not typically possess built-in computing power similar to that of a high-end computer or server. Instead, humanoid robots often rely on external computing systems to perform complex tasks and computations while they execute simple tasks. Conventional humanoid robots generally consist of a combination of hardware components, sensors, and actuators, along with embedded systems that enable basic processing and control functions. These embedded systems are responsible for handling low-level tasks, such as motor control and sensor data processing and actuator controls.

Humanoid robots are forced to increase their performance using Artificial Intelligence (AI) to make them more self-reliant and smart. An AI-based humanoid robot is a robot that is designed to resemble and interact with humans. It incorporates AI technologies to enable it to perceive its surroundings, make autonomous decisions, and perform multiple tasks. Effective collision avoidance strategies to overcome obstacles, often combine multiple approaches, using an array of infrared and proximity sensors, mapping, path planning, and dynamic adjustments to ensure safe, collision free and efficient robotic movements. Such robots are equipped with various infrared, tactile, proximity and other types of sensors, such as cameras, microphones, and touch sensors, to gather information from their environment. The AI algorithms process such sensory inputs to understand the operating environment and make informed decisions. However, processing the environment information requires fast analysis, deep learning, reinforced learning, and machine learning software modules to process various kinds of data that are computationally intensive. Conventional systems utilise general purpose microprocessors typically present in external servers that process the information and communicate the results to the AI robot resulting in a time delay. Due to their inherent hardware configuration, processing of commands occurs sequentially with very minimal or no parallel processing. This affects the speed of the robots translating into low productivity and efficiency.

The AI capabilities of humanoid robots can vary widely. Some robots are programmed with pre-defined behaviours and responses, while others use machine-learning techniques to learn from their experiences and improve their performance over time. Deep learning algorithms, a type of machine learning, have been used to enhance the cognitive abilities of humanoid robots, enabling them to recognize objects and faces, listen, understand, and generate speech, and even exhibit emotions.

The applications of AI-based humanoid robots are diverse. They can be used in areas such as healthcare, where they can assist with patient care and rehabilitation exercises. They can also be employed in education, where they serve as interactive tutors or companions for children with special needs. In the field of customer service, humanoid robots can provide assistance and information in public spaces like airports or shopping malls.

However, when it comes to more advanced computations and decision-making processes, humanoid robots often depend on external computing resources. These resources can include cloud-based servers or remote computers that handle the heavy computational load. The robot sends sensor data to the external computing system, which analyses the information, performs complex calculations or analysis, and sends back the instructions or commands to the robot. By leveraging external computing power, humanoid robots would benefit from more extensive computational capabilities, access to vast amounts of data, and the ability to leverage advanced algorithms and machine learning models. This approach allows for greater flexibility and scalability in terms of the tasks and applications that humanoid robots can perform. However, as humanoid robots were required to perform more and more intelligent tasks utilising artificial intelligence and deep learning algorithms, the amount of data that was analysed began to increase and external servers could not cope with the timing constraints. There would be significant time lag for every operation of the humanoid, which made them unsuitable for fast and real time applications such as contact lens manufacturing, electronic component inspection, sorting, packaging and many other manufacturing industries and other non-manufacturing applications as well.

While AI-based humanoid robots have made significant advancements, they still face challenges. Developing robots that can navigate complex environments, interact naturally with humans, and handle unpredictable situations remains to be developed. Nonetheless, ongoing research and technological advancements continue to drive the development of more sophisticated and capable AI-based humanoid robots.

The need for intensive data crunching requirements is a continuous challenge and therefore one immediate solution is to provide a coordinated robotic control system with high computational power within the humanoid robots to ensure quick and real time responses. It is worth noting that advancements in technology continue to evolve, and future generations of humanoid robots will require on-board computing power. With Semiconductor miniaturisation and significant increase in efficiency of processing power, it is now possible to incorporate multiple advanced Digital Signal Processors (DSPs) that can handle dynamically allocated tasks enabling design of high speed and highly intelligent anthropomorphic robots.

### SUMMARY

An aspect of this patent document is a powerful coordinated robotic control technology comprising on-board high-powered AI computer modules such as NVIDIA® AGX series modules, capable of processing extensive amount of data from multiple input sources, to perform different tasks in parallel using a dedicated set of processors within the AI computer modules, instead of communicating to external computers either on the cloud or servers. In particular, the technology may enable the utilisation of on-board processors to implement artificial intelligence and deep learning for the humanoid robots to perform a set of tasks without relying on external resources where real time responses are difficult to achieve.

Another aspect is an industry humanoid robot with onboard intelligence that can process information, make autonomous decisions inferencing the operating task based on commands, external interface inputs, deciphering on-the-fly images captured by cameras and speedily perform tasks without the need to send information to offline servers and wait for responses. Intelligence of the robots is enhanced through implementation of reinforcement learning, where they receive feedback in the form of rewards or penalties based on their responses for every command. Over time, the humanoid robot improves its decision-making process to achieve better outcomes in the form of accuracy, speed, consistency, and reliability amongst many other operating functions.

Another aspect is an ADCH system for integration into an inline automated system relevant to a specific process in a manufacturing environment, where full-fledged robots are not required.

Another aspect is a humanoid robot that is more autonomous and adaptive, allowing them to operate in various environments and execute complex tasks efficiently through deep learning techniques. Advanced robots utilise multiple types of sensors, such as cameras, remote sensing units, radar, transducers, amongst others, to gather data about their environment. Sensor fusion techniques combine data from such sensors and other external interfaces, enabling the robot to have a more comprehensive understanding of its surroundings that enable them to improve their AI responses over a period of time.

Another aspect is a humanoid robot that is more autonomous where the kinematic control of the robot is to be quickly calculated to move the end effector of the robot to a specified destination. This is achieved through on-board computing processors with the implementation of inverse kinematics to ensure smooth, accurate and non-jerky movements of the robot arm and enabling implementation of anthropomorphic features.

Another aspect is a humanoid robot with more than one dedicated on-board computing processor (e.g., NVIDIA® Jetson AGX Xavier series) so all data analysis, data manipulation, and other real time algorithms may be distributed across the parallel system architecture incorporated into the robot, to ensure ultra-high-speed responses for a particular command from module specific and device specific accessories. The goal is to ensure that these robots can respond to their environment and perform tasks in real-time, adapting to changing conditions and interactions.

Another aspect is enabling rapid transfer of huge tranches of data (for example, high resolution images) between different nodes or processors through USB C and Ethernet star network without the speed limitation of the common bus through which the boards may also communicate between themselves. Such rapid data transfer strategy enables the software application to create maps of the manufacturing environment using sensor inputs. These maps may be used to identify obstacles and plan collision-free and shortest trajectory paths by incorporating techniques like Simultaneous Localization and Mapping (SLAM) to determine the robot position and orientation within the mapped environment. Many of the analysed trajectory paths may further be stored and utilised as part of pre-defined behaviours or movements to perform specific tasks, enabling autonomous navigation of robots in an indoor and familiar environment. Use of multiple processors that are interconnected through multiple data transfer networks such as USB C, Ethernet and Common Bus architecture allows for extremely rapid data analysis and continuous updating of planned trajectory paths based on real-time sensor data to adapt to changing environmental conditions and avoid new dynamically occurring obstacles.

Another aspect is facilitating efficient data transfer for distributed real-time imaging and inference across multiple nodes, eliminating the common bottlenecks encountered in conventional multi-GPU server systems that rely on a shared bus architecture resulting in delayed responses and inefficient performance.

Advancements in robotics and AI have made it possible to create humanoid robots with increasingly sophisticated capabilities to perform complex tasks that require dexterity and precision. These robots often incorporate technologies such as computer vision, natural language processing, machine learning, and sensor systems to perceive and interact with the world around them resulting in intelligent anthropomorphic robots.

With rising demand for intelligent robots capable of executing complex tasks, the need for on board intensive computing requirements is required to implement such robots in applications such as self-driving vehicles that can navigate roads and avoid obstacles without human intervention, industrial robots to be deployed in clean room environments, robots in healthcare to assist in surgeries, rehabilitation and other hospital duties which may require extreme sanitised surroundings to prevent risk of infection spreading. They may also be deployed as agriculture robots for planting, harvesting, monitoring, and packing, and search and rescue operations to locate areas of disasters such floods, earthquakes, landslides, and other calamities.

### BRIEF DESCRIPTION OF DRAWINGS

This patent document, including the claims, will be better understood from reading the following description of non-limiting embodiments, with reference to the attached drawings:

FIG. 1 is a block diagram illustrating an example of an Advanced distributed computing hardware system that may be used for coordinated robotic control implemented within a humanoid robot.

FIG. 2 shows the configuration of a single board Advanced distributed computing hardware, comprising four processors, each processor consisting of a Graphic Processing Unit (GPU), an ARM based Central Processing Unit (CPU), a Vision Processing Accelerator (VPA), and a Deep Learning Accelerator (DLA)), handling different tasks and multiple types of interfaces that control and monitor the functions of the humanoid robot.

FIG. 3 is a block diagram illustrating a three-board advanced distributed computing hardware system showing multiple GPUs controlling multiple interfaces through a network of communicating modules and a common bus mounted through the main board.

FIG. 4 Illustrates a plan view of a single board advanced distributed computing hardware configuration.

FIG. 5 Illustrates a side view of a three-board advanced distributed computing hardware configuration.

FIG. 6 shows an isometric view of the three-board advanced distributed computing hardware system of FIG. 5.

FIG. 7 shows a front view of a humanoid robot with a built in advanced distributed computing hardware.

FIG. 8 shows an isometric view of a humanoid robot with a built in advanced distributed computing hardware.

The drawings are not necessarily to scale and may be illustrated by diagrammatic representations and fragmented views. In certain cases, details that are not necessary for an understanding of the embodiments or that render other details difficult to perceive, may have been omitted.

### DETAILED DESCRIPTION

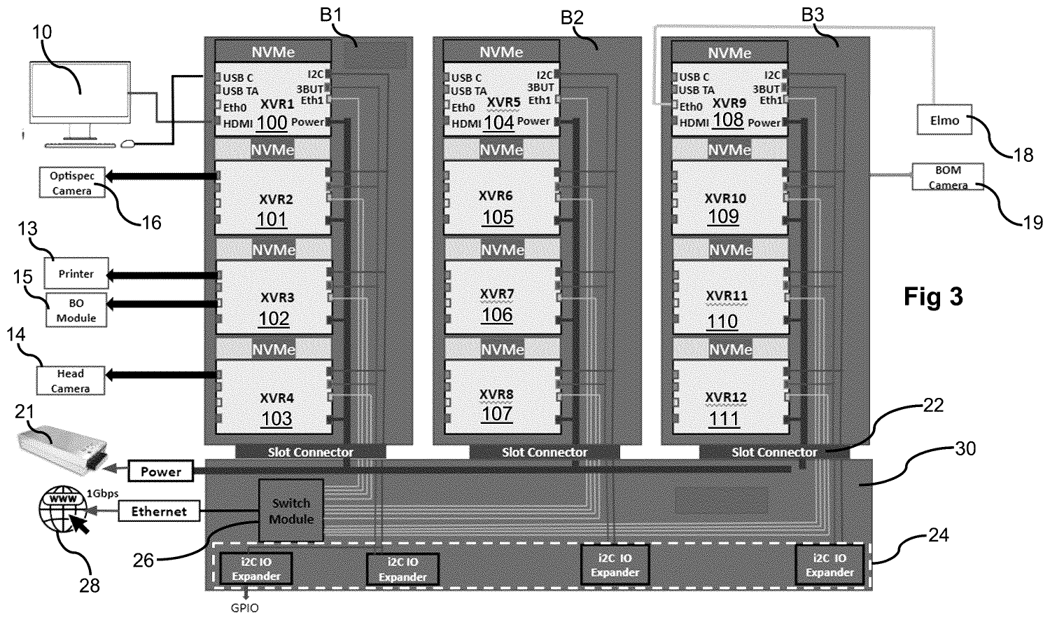

An Advanced Distributed Computing Hardware (ADCH) system that is implemented with peer-to-peer communication between a cluster of processors making up an action server, each processor comprising, a Graphic Processing Unit (GPU), an ARM based Central Processing Unit (CPU), a Vision Processing Accelerator (VPA) and a Deep Learning Accelerator (DLA), to perform a variety of tasks, is described. In particular, the ADCH system may allow coordinated processing of tasks assigned by the master processor 100 in FIG. 3 to the network of processors (101-111 in FIG. 3) residing in at least one server, through broadcast messaging and service calls with very minimal communication delays to achieve real time functionality of the robot. The network of processors may be able to accomplish various coordinated human-like complex, multifaceted tasks, or even simple coordinated tasks in real time, through parallel processing and pre-emptible services. Such pre-emptible tasks and many other established processes are stored within the robot in non-volatile memory and further fine-tuned and reinforced, through the use of machine learning and deep learning algorithms.

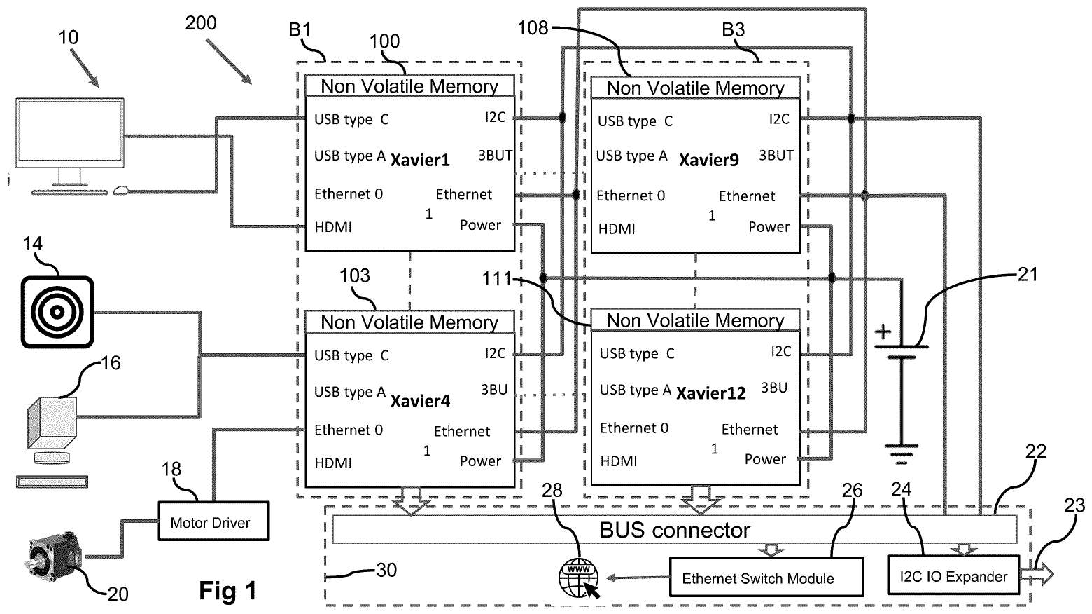

One of the embodiments uses a set of boards comprising a cluster of 12 processors (for example, the Jetson AGX series from NVIDIA®) 100 to 111 as shown in FIG. 1. One Ethernet port from each of the processors is routed to an Ethernet switch 26 to form a star networking topology. Peer-to-peer network is established between processes running on each pair of processors (100 to 111 in FIG. 1) in the cluster and they communicate using different modes such as, broadcast messages, services, and action servers.

Broadcast messages can be published by any process in the network without any knowledge of the subscribers to the messages. It is a typical many-to-many connection used for continuous data flow.

Services are implemented through short duration remote service calls that are executed sequentially otherwise referred to as a synchronous service call. During the execution of a remote service call, the scheduled call will stay active and will not be pre-emptible by another remote service call. A typical service thread therefore stays dedicated to a single service call until the completion of execution.

Action servers and clients establish tight coupling of two or more processes to run different tasks by the assigned server, with the option to provide feedback during and at the end of execution of a service call or request from the client. It is important to note that action servers are designed to be pre-emptible and non-blocking, which means they are capable of multitasking.

All processes are designed to be fine grained and modular such that each process performs a well-defined task and has invokable interfaces. These interfaces are exposed to any of the above-mentioned communication modes (e.g., broadcast messages and remote service calls) by the process based on the requirement.

Reliable safety systems are integrated into the ADCH. These systems include collision detection through the utilisation of infrared and proximity sensors, emergency stop mechanisms, and fail-safes to prevent harm to the robot or its surroundings and a self-diagnostic feature to detect and report malfunctions in real time, within the computer and faulty or inappropriate responses from the external hardware interfaces. In addition, password protected data security and privacy is ensured within the ADCH, which enable processing and storing data locally, without the risk of data exposure during transmission to external servers, especially where sensitive applications are involved.

The modular processes are deployed in all the twelve processors (100-111 in FIG. 1) and one master processor 100 is enabled to dictate which process is assigned to which processor. The master 100 is connected to a display and mouse 10 in FIG. 1 through the HDMI port for the purpose of training, configuring, programming, and invoking any of the tasks that may be required to perform an action. Given the open nature of the processes and network topology, the master has the capability to dynamically assign a particular processor for a specific process depending on the processing power required and the processor's load at any stage. In effect, the master manages the cluster like an Operating System (OS) scheduler managing a multi core processor.

Referring to FIG. 1, the ADCH system 200 comprises three boards B1, B2, and B3, each consisting of four Xavier processors. In total a cluster of twelve processors (100 to 111 in FIG. 1) are available to perform a multitude of tasks in parallel through high-speed communication via the dedicated PCI bus on the main board 30. Due to space constraints, not all Xavier processors are shown in FIG. 1. In the embodiment shown in FIG. 1, 100 is the master that manages the process assignments for processors 101-111. The external interfaces such as motor 20 through a motor driver 18, cameras 16 and 14, sensors (not shown), are connected to another processor 103 in FIG. 1. All Ethernet and I2C connections from each processor are terminated at the bus to connect with the main board 30 through the bus connector 22. Inter board communication may be enabled to work between peer-to-peer or through the high-speed bus interconnecting the three processor boards B1, B2 and B3. The main board 30 further provides general input/output connections 23 through the I2C I/O expander 24 and communication to the Internet 28 via the Ethernet switch module 26. Power is supplied by 21. Due to the high data speeds required by the cameras 14 and 16, they are interfaced to the USB C port that offers peak speeds of up to 40 Gbps that enables real time data transfer especially when using high-resolution cameras. USB A ports are utilised where data transfer speeds below 10 Gbps are adequate for the accessory connected. 3BUT is an I/O port where sensors and/or switches are connected (not shown) to achieve action status feedback, hard reset and any other hardware input/output configuration options that may be required.

The ADCH system 200 operating system is programmed to configure the twelve processors to execute different types of tasks. For example, in the embodiment shown in FIG. 1, processor 100 and 101 are assigned to be control nodes, 102 and 103 as planning and sequencing nodes respectively, 104 and 105 as user interface and debugging nodes, and the rest of the processors (processors 106-111) assigned as imaging nodes. The ADCH system software application offers the flexibility to dynamically change the node assignment depending upon the processor loading to expedite processing of data to achieve a high degree of real time performance. The system is also designed to scale up the performance by adding more processors or reassigning processors for varied tasks.

The ADCH system is built into the robot and all operations are distributed through nodes that operate in a multitasking environment offering an extensive parallel processing environment. Nodes are also referred to as processors which are each connected to non-volatile memory that enable storage of the status condition of a particular sequence to ensure easy restoration of robot movements in the event of a stoppage or power loss conditions through a well-coordinated control mechanism using the star network. Conventional control systems require a long recovery process starting from communicating to an external server, waiting for the status of the last known condition of the machine or robot to restarting the robot from a specific home position followed by commands to restore the machine or robot to the last known position. The nodes may also store the results of all or any configured data analysis results (e.g., Viz image inspection) which can be utilised by algorithms to build the artificial intelligence database and enhance machine learning. Nodes 100 and 101 function as control nodes. They assign tasks, keep track of the status of every other processor and their respective computing loads at any given time and deploy neural networks through any of the other free nodes 102 to 111. Due to the nature of the real time demands of the robot a feature is implemented wherein the software application can control the processing to be executed either by software or hardware ensuring fast responses. The nodes also manage power consumption of the system by turning off the clocks to the unused nodes effectively reducing the thermal dissipation of the robot. Nodes 102 and 103 manage the planning and sequencing respectively of the ADCH external interface with full duplex functionality and ensure optimum usage of computing power. The planning and sequence control nodes aid in operating the robot movements in the smoothest and fastest trajectory paths through optimum calculation of robot joint angles and optimised trajectory planning to maintain balance and avoid collisions with intermediate obstacles. Nodes 104 and 105 nodes control the User Interface (UI) and debugging operations respectively during the training and configuration of the robot. Nodes 106 to 111 are dedicated to vision analysis that include imaging, trajectory planning, balance control through optimum robot joint angle, algorithms for inverse kinematics, processing, and feedback of results to the network of nodes and the master node 100. The master node 100 in the ADCH can allocate any of the nodes for audio support when required, wherein the robot can recognise audio commands (voice recognition), speech recognition, natural language processing, and decision-making enabling the understanding of a natural language command and ability to generate an appropriate natural language response. Machine learning and deep learning techniques are often employed to improve the robot's capabilities in these areas and respond accordingly to perform a task or set of tasks. Furthermore, feedback in the form of voice responses make the robots scalable and flexible to adapt to a variety of applications. Advanced audio features may be implemented where it is necessary for the robot to understand and analyse multilingual commands to implement them in various countries without the need for the user to utilise a specific language user interface (UI) to operate the robot.

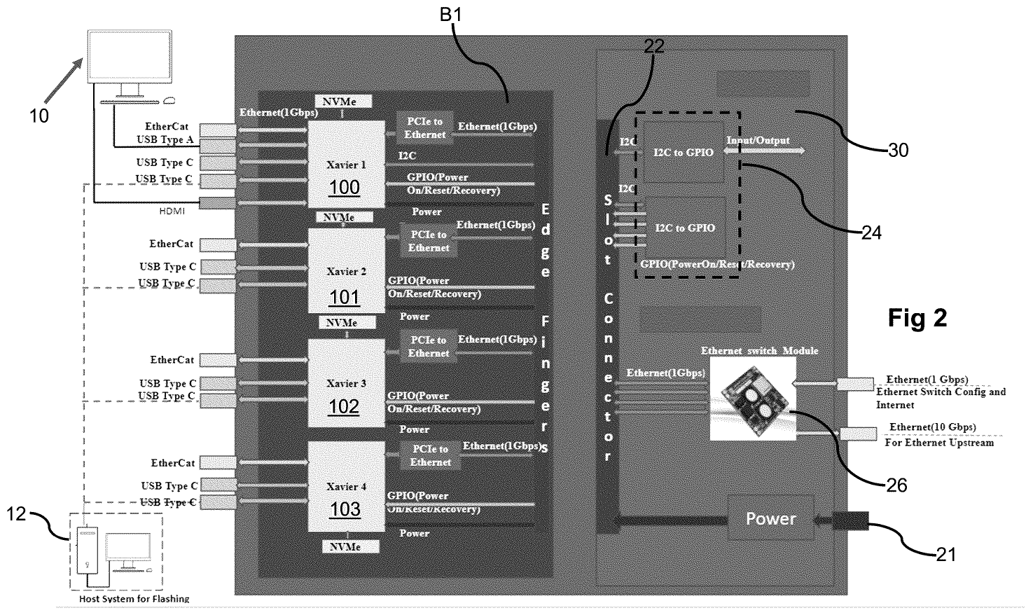

FIG. 2 represents a typical board layout of a single computing board B1 otherwise referred to as System on Module (SOM) comprising four Xavier processors or nodes, with the external interfaces terminated to one side of the board and communicating interfaces to the main board 30 via the connector 22. Some of the interfaces are on-board WiFi, Bluetooth, General Purpose I/O. Ethernet, or other communication interfaces to interact with humans or other devices. This connectivity allows them to receive commands and transmit information. The General Purpose IO (GPIO) is provided through the I2C interface board 24 and the Ethernet communication interface via the Ethernet switch board 26. Interface 12 is a host flashing system which plays an important role in configuring the ADCH system by enabling functionality such as uploading/downloading of firmware, configuration and uploading/downloading of all other relevant operating parameters. The host flashing computer 12 plays a key role in setting up the ADCH system integrated with a software development kit module to add/modify the operating system kernel of the processor(s) and customise the software application, bootloader and device drivers, to perform a specific set of tasks for processing different products making the ADCH scalable and flexible to adapt to changes in the robot application. The host flashing computer 12 can also be used to flash other ADCH systems controlling other robots performing the same set of operations, by a process called mirroring or cloning, so an optimised program of a said robot may be copied and cloned to operate another robot, to ensure a stable and consistent operating environment.

FIG. 3 illustrates a block diagram of a typical ADCH system comprising three computing boards B1, B2 and B3 mounted on a main board 30 through slot connectors 22. FIG. 3 also shows how the common signals are interfaced between multiple processors such as 100-111 to achieve a powerful yet effective system to monitor and control the various devices such as the OptiSpec® camera 16 and 19, printer 13, BO module 15, a robot head camera 14, a motor controller referred to as Elmo 18. The main board provides access to the Internet via Ethernet switch module 26, and access to input/output signals through the I2C GPIO expander 24 to communicate to the external devices. The configuration shown in FIG. 3 is designed to be small in size (i.e., a small form factor) to be able to fit into a robot that has adequate data processing power built into it with very minimal requirement to communicate to an external server for its computing needs. A scalable robotic environment is a possibility with such a distributed and self-contained system.

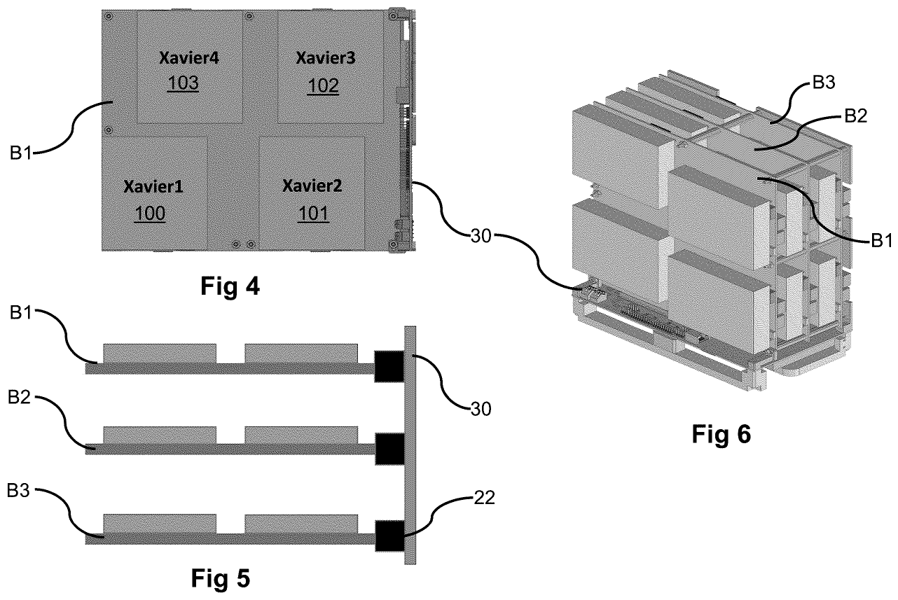

FIGS. 4, 5, and 6 shows the plan view, side view and isometric view of the ADCH system that may be easily deployed within a robot.

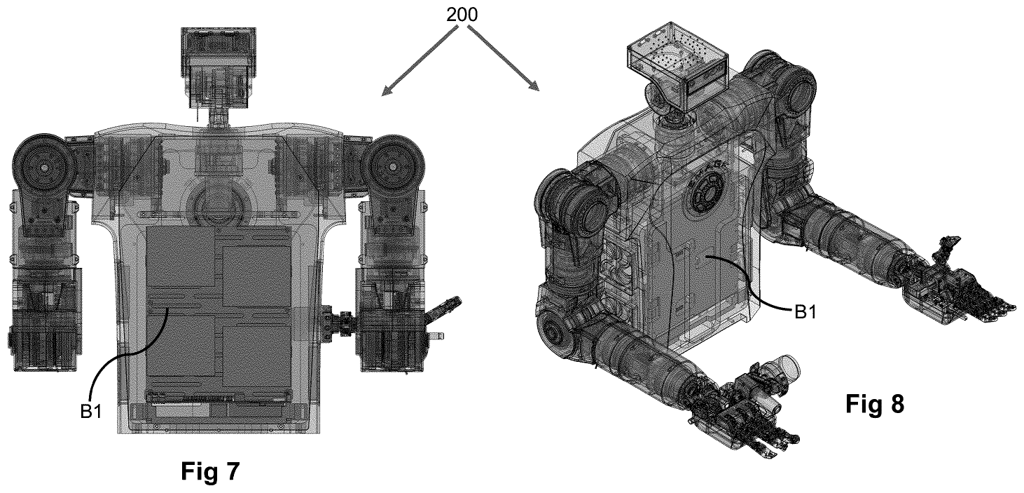

FIGS. 7 and 8 shows a front view and isometric view of the robot incorporated with the ADCH. The various devices mounted within the robot are not shown.

Reference was made to the illustrated drawings and specific language was used herein to describe the same. It will nevertheless be understood that no limitation of the scope of the technology is thereby intended. Alterations and further modifications of the control system features illustrated herein are to be considered within the scope of the description.

It will be recognized, however, that the technology may be practiced without one or more of the specific details, or with other methods, hardware components, interface devices, etc. Well-known modules such as loading and unloading handling or operations are not shown or described in detail.

The subject matter defined in the appended claims is not necessarily limited to the specific features and operations described above. Rather, the specific features described above are disclosed as example forms of implementing the claims. Numerous modifications or arrangements may be devised without departing from the spirit and scope of the following claims.

1. A coordinated control system designed with a small form factor that can be located within a robot or an automated inline manufacturing system, comprising
an on board Advanced Distributed Control Hardware (ADCH) configured with Artificial intelligence enabled processors incorporated within a System on Module (SOM) board, each SOM comprising four processors or nodes;
the ADCH interfaced with a camera, a motor, a general purpose I/O through I2C expander, an audio interface, the Internet, and wireless communication transmitter and receiver to send and receive commands and any other data;
the ADCH electrically connected to a plurality of sensors for perceiving the environment and collecting data from infrared, tactile, proximity and other types of sensors;
the ADCH in data communication with an external host flashing computer dedicated for uploading/downloading firmware, cloning, and configuration setup;
the ADCH comprising a non-volatile memory for storing control algorithms, configuration files, and other essential data;
an HDMI-based user interface in data communication with the ADCH, the HDMI-based user interface for robot operation, training, and setup;
an USB C- or Ethernet-based internal star network in data communication with the ADCH, the HDMI-based user interface for high-speed communication bypassing the standard PCI bus interface bus; and
an Ethernet switch board in data communication with the ADCH, the HDMI-based user interface enabling multiple boards to access the Ethernet for both internal communication within the star network and external Internet access.

2. The coordinated control system of claim 1, further comprising:
an artificial intelligence enabled system for processing data locally in the ADCH enabling a significant reduction in latency to make autonomous decisions supported by artificial intelligence-based machine learning and deep learning algorithms; and
a user interface for robot interaction, wherein a HDMI-based user interface comprises a display, a mouse for both visual and voice communication with human operators;
wherein the ADCH comprises multiple processors each consisting of a Graphic Processing Unit (GPU), an ARM-based Central Processing Unit (CPU), a Vision Processing Accelerator (VPA), and a Deep Learning Accelerator (DLA) for analysing the environment and achieving real-time performance.

3. The coordinated control system of claim 1, further comprising:
a power management feature within the ADCH to optimise power or battery usage by managing processors and disabling unused processor clocks to ensure low thermal dissipation.

4. The coordinated control system of claim 1, further comprising:
a self-diagnostic system to detect and report malfunctions in real-time, within the computer, and to detect and report faulty or inappropriate responses from the external hardware interfaces.

5. The coordinated control system of claim 1, further comprising:
data security and privacy features that enable processing and storing data locally in the non-volatile memory, without the risk of data exposure during transmission, which can be crucial for sensitive applications.

6. The coordinated control system of claim 1, further comprising:
a hot flashing computer in data communication with the ADHC, the hot flashing computer dedicated to modify an operating system kernel of multiple processors in the ACDH to customise a software application, a bootloader, and device drivers aiding in scalability and flexibility.

7. The coordinated control system of claim 1, wherein the ADCH enables
a distributed and self-contained robotic environment which is scalable and adaptable to new applications.

8. A coordinated control method for a robot or an automated inline system in a manufacturing environment, the method comprising:
utilizing a built-in computer comprising Advanced Distributed Control Hardware (ADCH) to coordinate and execute tasks related to a production process, including material handling and quality control. receiving external production instructions via Wifi, Bluetooth, or Ethernet from a central manufacturing control system or from a software application residing in a built-in computer;
rapidly communicating within the ADCH through broadcasting messages that can be published by any process in the star network without any knowledge of the subscribers to the messages resulting in a typical many-to-many connection for continuous data flow;
communicating data over an established peer-to-peer network between processes running on each pair of processors;
managing synchronous service calls implemented through short duration remote service calls which are executed sequentially, staying dedicated and active during its execution, and not being preemptible by another remote service call;
selectively scaling the functionality and speed of the ADCH by reassigning unused nodes or processors aiding scalability and flexibility;
dynamically allocating nodes or processors by the master node, to distribute the tasks efficiently for maximum computing speed during data and image analysis during normal operation, debugging and user interface utilisation during training and configuration; and
establishing tight coupling of two or more processes by action servers and clients to run different tasks by the assigned server, with the option to provide feedback during and at the end of execution of a remote service call or a service request from a client and wherein action servers are designed to be preemptable and non-blocking, enabling them to execute multiple tasks with password protected data security and privacy features within the ADCH to process and store data locally, without the risk of data exposure during transmission to external servers when used in sensitive applications.

9. The coordinated control method of claim 8, wherein;
processes are designed to be fine grained and modular to ensure each process performs a well-defined task with invokable interfaces.

10. The coordinated control method of claim 9, wherein the invokable interfaces are exposed to all communication modes (broadcast messages and remote service calls) by the process based on the requirement.

11. The coordinated control method of claim 8, wherein the sequence of robot movements are analysed and calculated to manage the robot joint angles for maintaining balance.

12. The coordinated control method of claim 8, wherein the trajectory paths of the robot are planned through implementation of algorithms for inverse kinematics to ensure smooth, non-jerky and accurate movements enabling implementation of anthropomorphic features.

13. The coordinated control method of claim 8, wherein pre-defined behaviours or movements are utilised to perform specific tasks for autonomous navigation of robots in an indoor and familiar environment.

14. The coordinated control method of claim 8, wherein effective Artificial Intelligence (AI) algorithms are implemented for object recognition, speech recognition, natural language processing and decision-making resulting in understanding a natural language speech command and generating an appropriate natural language response.

15. The coordinated control method of claim 8, wherein the vision systems aid in understanding the manufacturing environment and quality inspection capabilities complimented by Artificial Intelligence (AI) inferencing, deep learning, and reinforced learning for an efficient end-to-end autonomous application.

16. The coordinated control method of claim 8, wherein efficient data transfer is facilitated through the Ethernet and USB star network and interfaces within the ADCH to enable distributed real-time image processing and inferencing across multiple nodes as well as to overcome common bottlenecks encountered in conventional multi-GPU server systems that rely on a shared bus architecture.
